(19) United States
(12) Patent Application Publication
(10) Pub. No.: US 2009/0257013 A1
(43) Pub. Date: Oct. 15, 2009

(54) LIQUID CRYSTAL DEVICE AND METHOD OF MANUFACTURING THE SAME

(75) Inventors: Akira Sakai, Kawasaki-shi (JP); Yohei Ishida, Honjo-shi (JP); Yasufumi Asao, Atsugi-shi (JP); Hirokatsu Miyata, Hadano-shi (JP); Philip J. Martin, West Lindfield (AU)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/442,461

(22) PCT Filed: Jun. 5, 2008
(86) PCT No.: PCT/JP2008/060722

§ 371 Date: Mar. 23, 2009

(30) Foreign Application Priority Data
Jun. 6, 2007 (JP) 2007-150304

(51) Int. Cl. G02F 1/1337; G02F 1/13

(52) U.S. Cl. 349/124; 349/187

(57) ABSTRACT

A liquid crystal device has a pair of substrates, an alignment film formed at least on one of the pair of substrates and liquid crystal showing an orientation defined by the alignment film. The alignment film is a carbon film having a cross-sectional structure inclined relative to the direction of the film thickness by a constant angle.

### TECHNICAL FIELD

The present invention relates to a liquid crystal device and a method of manufacturing the same. More particularly, the present invention relates to a liquid crystal device having an alignment film containing carbon as principal ingredient and a method of manufacturing the same.

### BACKGROUND ART

Flat panel displays that have been developed and marketed in recent years cover a wide variety of sizes and include medium to small size displays that are employed as monitors of personal computers and portable telephone sets and wide displays of large television sets. Of such flat panel displays, liquid crystal display devices (LCDs) are most popular.

Liquid crystal display devices finding applications in television sets mainly include those of a vertical alignment (VA) mode where liquid crystal is oriented perpendicularly relative to the substrate and inclined from the perpendicular direction by a voltage and those of an in-plane switching (IPS) mode where liquid crystal is oriented in parallel to the substrate and changes its bearing in the plane of the substrate according to an electric field that is parallel to the plane of the substrate.

A technique of rubbing a polymer film, typically a polyimide film, is being popularly employed to orient liquid crystal in parallel with the substrate. Rubbing is a technique of rubbing the surface of the polymer film with cotton fabric to extend the polymer film in a direction and make the polymer film oriented. However, defects referred to as “scratch scars” can be produced by rubbing and the rubbing debris produced from the rubbed and scraped surface can get into liquid crystal.

Recently, inorganic substances have been often employed as materials for alignment films. Since a film of an inorganic substance can hardly be oriented by rubbing unlike a polymer film, the film is typically oriented by oblique evaporation or oblique ion irradiation. The technique of forming an alignment film by oblique evaporation of SiO on a substrate is well known.

Since liquid crystal is oriented substantially in parallel with the substrate in an IPS mode, an inorganic film having large surface energy is preferably used. Thus, carbon is more suitable than SiO. However, since carbon has a high melting point, no vapor is generated if an electron beam is made to strike it so that it is difficult to form a carbon film by evaporation.

Japanese Patent No. 3738990 proposes an alignment film forming method of providing a diamond-like carbon (DLC) film that is formed by sputtering with anisotropy by oblique irradiation of an ion beam onto the DLC film.

U.S. Pat. No. 5,433,836 discloses a method of forming a thin film by curving the trajectory of the plasma beam generated by vacuum arc discharge in a magnetic field and removing large droplets so as to irradiate the plasma beam onto a substrate.

This method is referred to as filtered arc deposition (FAD) method and characterized in that the method can prevent large liquid droplets generated by arc discharge from getting to the substrate by curving the beam by means of a magnetic field and hence can form a uniform film.

Dongping Liu et al., “Influence of the incident angle of energetic carbon ions on the properties of tetrahedral amorphous carbon (ta-C) films”, Journal of Vacuum Science and Technology, 2003, A21 (5), 1665-1670 reports a structural analysis of a carbon film prepared by the FAD method. According to the report, a carbon plasma beam generated by vacuum arc discharge is irradiated onto a substrate and the angle of irradiation is changed from perpendicular (0°) to 60° to find that an amorphous carbon film containing the sp³ bond component to a large extent, or a diamond-like carbon film, is formed when the angle of irradiation is perpendicular and that the sp² bond component increases and a graphite-like film is formed as the angle of irradiation is raised.

### DISCLOSURE OF THE INVENTION

In an aspect of the present invention, there is provided a liquid crystal device having a pair of substrates, an alignment film formed at least on one of the pair of substrates and liquid crystal illustrating an orientation defined by the alignment film, wherein the alignment film is a carbon film having a cross-sectional structure inclined relative to the direction of film thickness by a constant angle.

In another aspect of the present invention, there is provided a method of manufacturing a liquid crystal device including liquid crystal sandwiched between a pair of substrates including a step of forming an alignment film at least on one of the pair of substrates and a step of arranging the pair of substrates opposite to each other and bonding them together with liquid crystal sandwiched between them, characterized in that

the step of forming the alignment film is a step of forming a carbon film on either of the pair of substrates by generating a carbon plasma beam by arc discharge, using graphite as cathode, curving the trajectory of the carbon plasma beam by means of a magnetic field and irradiating the carbon plasma beam onto the substrate from a direction inclined relative to the surface of the substrate.

Thus, according to the present invention, an inorganic alignment film capable of alignment liquid crystal in a direction can be prepared without rubbing. The obtained alignment film illustrates high surface energy and a small pretilt angle of liquid crystal so that a display illustrating excellent viewing angle characteristics can be obtained by applying the alignment film to a liquid crystal device of IPS mode.

### BRIEF DESCRIPTION OF THE DRAWINGS

FIG. 1 is a schematic illustration of a film forming apparatus using the FAD method to be used for the manufacturing method according to the present invention.

FIG. 2 is a schematic illustration of the arrangement of an electric magnet for scanning an ion beam on the surface of a substrate.

FIGS. 3A and 3B are schematic cross-sectional views of carbon films formed respectively by oblique irradiation (FIG. 3A) and perpendicular irradiation (FIG. 3B) of a carbon plasma beam.

FIG. 4 is a schematic cross-sectional view of a liquid crystal device according to the present invention illustrating the configuration thereof.

FIG. 5 is a schematic illustration of transmission of light of a liquid crystal device according to the present invention.

FIGS. 6A and 6B are schematic cross-sectional views of the liquid crystal device according to the present invention used in an example.

### BEST MODE FOR CARRYING OUT THE INVENTION

The inventors of the present invention compared a carbon film formed by the FAD method and having an angle of irradiation of 0° and a carbon film also formed by the FAD method and having an angle of irradiation of 60° as liquid crystal alignment films and the latter unifies liquid crystal and orients the liquid crystal substantially in parallel with the substrate and got to this invention.

Now, the method of manufacturing a liquid crystal device according to the present invention will be described below.

### 1. Film Forming Step

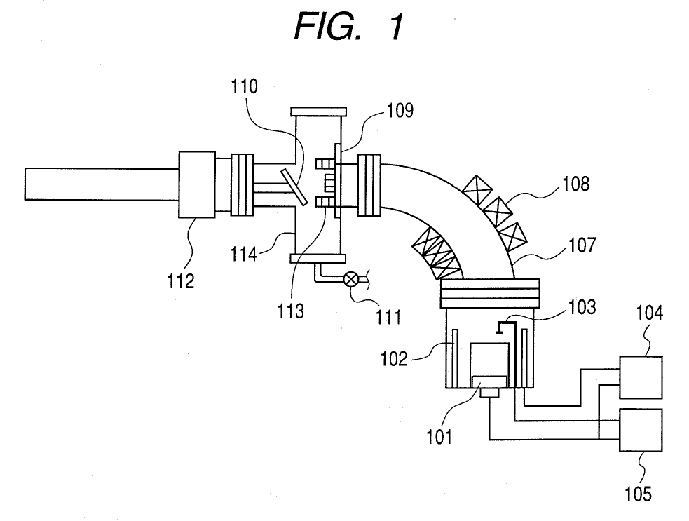

FIG. 1 is schematic illustration of a vacuum arc plasma film forming apparatus to be used for forming a liquid crystal alignment film according to the present invention.

A plasma beam is generated from a cathode 101 by arc discharge and the direction of the plasma beam is curved by means of a magnetic field to form an excellently directional plasma beam, which is then irradiated onto a substrate. Graphite (purity: 99.999%) is employed as the material of the cathodes 101.

Trigger electrode 103 is supplied with a voltage from an arc power source 105 and induces an arc between itself and the cathode 101. An electric spark arises between the cathode 101 and the trigger electrode 103 as the trigger electrode 103 is temporarily brought into contact with the surface of the cathode 101 and pulled back. The electric spark reduces the electric resistance between the cathode 101 and the trigger electrode 103 to produce a vacuum arc. While a DC arc is normally employed, a pulse arc may also advantageously be employed.

The cathode material is ionized at the cathode by the arc discharge to generate plasma, which is a mixture of electrons and carbon ions. Carbon ions and elections jump out from the surface of the cathode 101 and move toward the anode 102 at high speed. While the anode 102 is provided with a positive potential of 20 to 30V relative to the cathode 101, carbon ions ride over the potential barrier of the anode 102 so as to be emitted into the plasma duct because the carbon ions have kinetic energy of 50 to 70V. A substantially parallel carbon plasma beam is produced in this way.

Carbon plasma can be taken out from the space where the arc discharge is taking place without any external force applied to it. The kinetic energy of carbon ions jumping out from the surface of the cathode is determined in the course of ionization on the surface of the cathode.

The behavior of the formed plasma is totally different from the behavior of a pure ion beam or a pure electron beam. The magnetic field for deflecting an ion beam or an electron beam needs to be designed highly accurately and is often required to be very strong. On the other hand, a plasma beam can be deflected with ease by means of a weak magnetic field. This is because the trajectory of electrons is firstly bent by the magnetic field and positive ions follow the trajectory. This phenomenon is referred to as “plasma streaming effect”.

Electrons and carbon ions in arc plasma are accelerated by a voltage applied from the anode power source 104 to pass through the anode 102 and are led into a plasma duct 107. The plasma duct 107 is provided with a toroidal coil 108 to form a magnetic field that runs in the direction of the duct. Plasma in the magnetic field bends its trajectory to pass through the shutter 109 and is led to the substrate 110 in the film forming chamber 114. The substrate 110 is introduced from the load lock chamber 112.

Not only plasma of the substance of the cathode but also relatively large particles that are referred to as droplets are produced in an ordinary arc discharge. Such droplets obstruct the process of forming a uniform film as they deposit on the surface of the substrate. However, since the trajectory of plasma is bent and led to the substrate by means of the magnetic field of the toroidal coil 108 in the vacuum arc plasma film forming apparatus of FIG. 1, massive droplets get out of the trajectory in this process and do not reach the substrate 110.

The flow of carbon plasma generated from the cathode 101 becomes highly directional in the curved plasma duct 107 and is led into the film forming chamber 114.

Ar gas is introduced into the film forming chamber 114 by way of a valve 111. As Ar gas is introduced, the partial pressure of Ar in the apparatus is made equal to 1.0×10⁻¹ Pa. Arc plasma is operated with a voltage of 30V and an electric current of 80 A to obtain an ion current of about 200 mA.

The film forming surface of the substrate 110 where a film is formed is arranged obliquely relative to the flow of plasma in the film forming chamber 114. The substrate 110 is a non-alkali glass substrate of 0.7 mm thick and a 20 nm-thick ITO film is formed on the surface of the substrate 110.

A 100 nm-thick carbon film was obtained by irradiating a carbon plasma beam onto the substrate 110 for 30 seconds. Thus, the film forming rate is 200 nm/min. The film forming rate of the conventional sputtering process for producing amorphous carbon is tens of several nm/min and hence the film forming rate of the FAD method is higher than the film forming rate of the conventional sputtering process by a digit.

A bias voltage of a DC, an RF AC or a pulse current may be applied to the substrate 110. With this arrangement, the speed of ions getting to the film can be controlled.

The flow rate per unit area of the cross section, or the flux density, of a plasma beam, illustrates a certain distribution in the cross section and the center of the beam illustrates a higher density than the periphery of the beam. The diameter of an ion beam is basically defined by the size of the cathode. When the size of the substrate exceeds the diameter of the ion beam, the film thickness illustrates a distribution if the direction of evaporation is maintained constantly. Any distribution of the film thickness should be avoided because the distribution adversely affects not only the orientation of liquid crystal but also the drive characteristic of liquid crystal.

According to the results of the experiments conducted by the inventors of the present invention, raster-scanning an ion beam onto a substrate is effective for obtaining a uniform film thickness. Two pairs of electric magnets 113 are arranged at the entrance of the film forming chamber 114 of FIG. 1 to produce a magnetic field extending in a vertical direction and a magnetic field extending in a horizontal direction, which are then moved with time so as to shift the ion beam perpendicularly relative to the moving direction thereof and make the ion beam scan on the substrate.

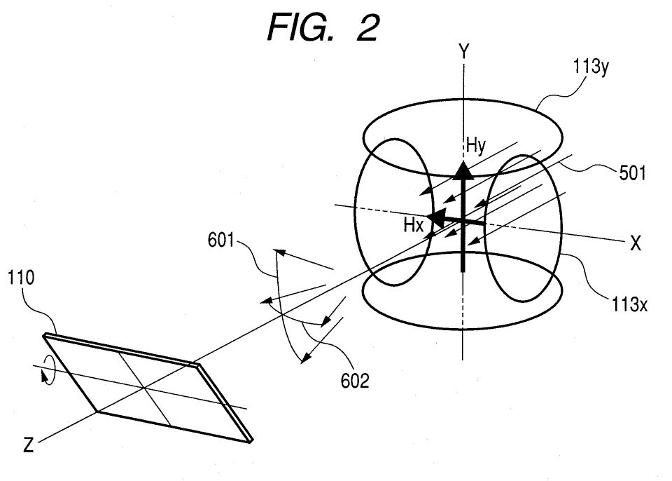

FIG. 2 is a schematic illustration of the arrangement of electric magnet 113. When the ion beam 501 is made to strike the substrate in the Z-direction, a magnetic field Hx is formed by a coil 113x in the X-direction while a magnetic field Hy is formed by a coil 113y in the Y-direction.

The ions that pass the magnetic fields are deflected in the Y-direction within a predetermined range 601 as the Hx is changed alternatingly and in the X-direction within a predetermined range 602 as the Hy is changed alternatingly.

The frequency and range of the scan of beam can be changed by controlling magnetic fields of Hx and Hy by means of the coils 113x, 113y respectively.

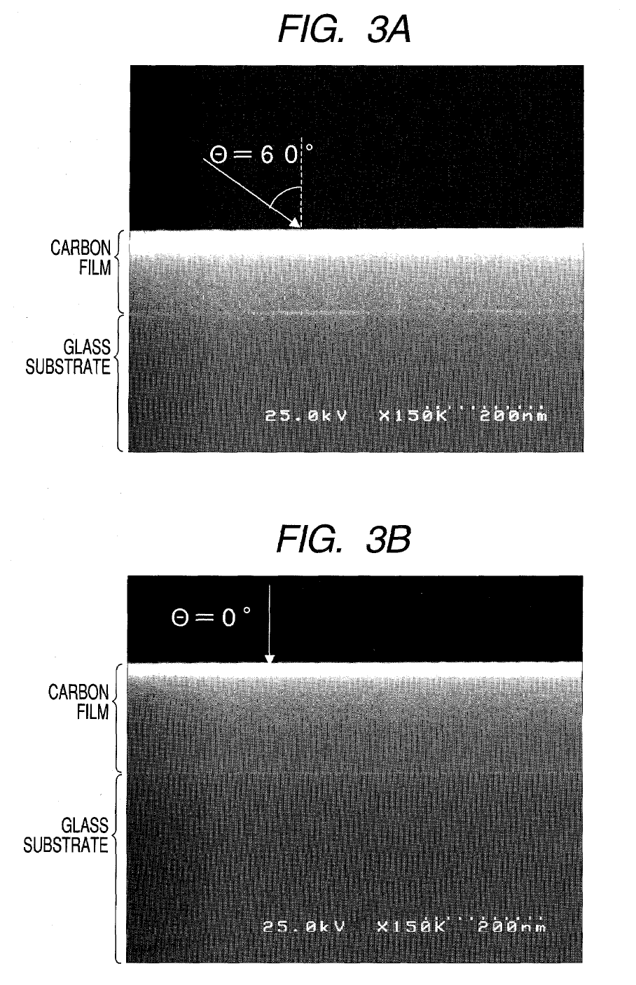

FIGS. 3A and 3B are schematic cross-sectional views of carbon films obtained by the above-described method and observed through a scanning electron microscope (SEM).

FIG. 3A is a photograph of a cross section of an about 150 nm-thick carbon film and an underlying glass substrate. The carbon film was formed by arranging the substrate obliquely relative to the running direction of carbon plasma beam by an angle of θ=60°.

FIG. 3B is a photograph of a cross section of an about 200 nm-thick carbon film and an underlying glass substrate. The carbon film was formed by arranging the substrate perpendicularly (θ=0°) relative to the running direction of carbon plasma beam.

The direction of the carbon plasma beam runs along the photograph for both of the films of FIGS. 3A and 3B as indicated by arrows. It will be appreciated that the carbon plasma beam is made to irradiate from above left with an angle of 60° relative to the normal of the substrate in FIG. 3A.

By comparing FIGS. 3A and 3B, it will be seen that an oblique pattern is observed on the cross section of the film in FIG. 3A while no such clear pattern can be observed in FIG. 3B. The pattern of FIG. 3A illustrates a constant angle both in the film thickness direction and in the film surface direction, although the angle does not agree with the angle of incidence of the plasma beam.

While it is not clear to date if the pattern corresponds to the pillar structure that can be observed in the case of oblique evaporation or not, the film of FIG. 3A clearly illustrates a cross-sectional structure that is inclined relative to the film thickness direction. Additionally, since the angle is constant in the film thickness direction and the pattern is uniform, it is clear that the pattern illustrates the structure formed continuously in the growth process of the carbon film.

Such a structure that is specific to a carbon film formed by the FAD method gives rise to an alignment effect on liquid crystal as will be described below.

### 2. Liquid Crystal Cell Forming Step

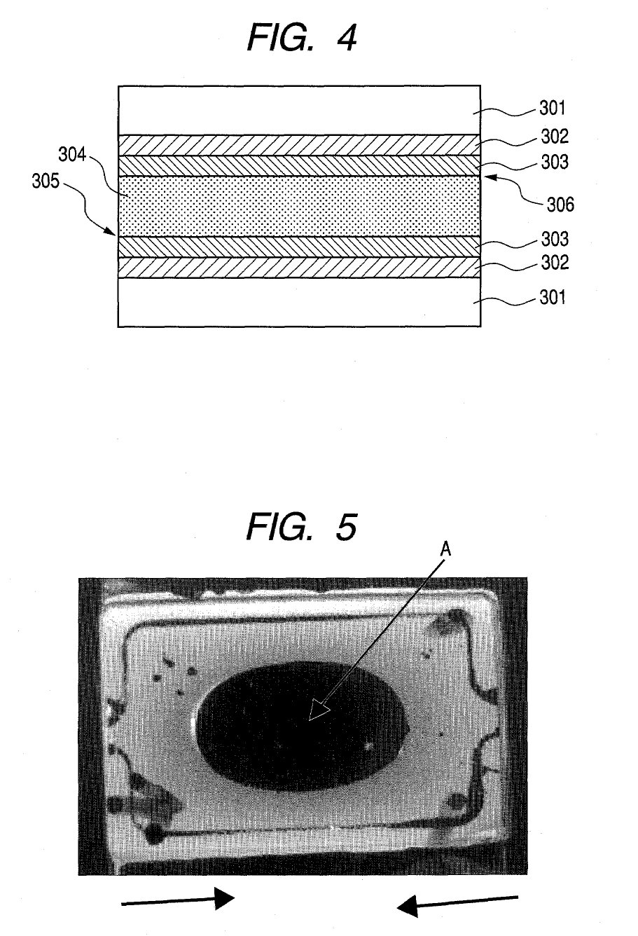

Two substrates carrying respective carbon films formed in the above-described film forming step are brought in and bonded to each other to produce a cell. FIG. 4 schematically illustrates a cross section of the cell. In FIG. 4, 301 denotes glass substrates and 302 denotes electrodes, while 303 denotes alignment films. The alignment film of each of the substrates is formed by carbon plasma beam irradiation in the directions indicated by arrows 305 and 306. The cell of FIG. 4 is formed by bonding the two substrates such that the ion irradiation directions 305 and 306 run in parallel with each other. Since liquid crystal molecules are arranged substantially completely in parallel with each other on the substrates of a liquid crystal cell prepared by the manufacturing method according to the present invention as will be described hereinafter, the two substrates may be bonded not in parallel but in anti-parallel. The gap separating the substrates is held to a constant value by means of spacers (not illustrated).

Then, liquid crystal 304 is injected into the cell. The liquid crystal that is filled in the cell may illustrate negative dielectric anisotropy or positive dielectric anisotropy. Liquid crystal illustrating positive dielectric anisotropy MLC-2050 available from Merck was injected in the above instance.

The prepared liquid crystal cell was arranged between a pair of polarizing plates arranged as crossed and observed for transmission of light.

FIG. 5 schematically illustrates the outcome of the observation. In FIG. 5, arrows 305 and 306 indicate the directions of plasma beams irradiated at the time of forming carbon films on the respective substrates. The liquid crystal cell illustrates the same cross section as the one illustrated in FIG. 4.

The dark area A at the center of FIG. 5 is the area where no liquid crystal was injected for the purpose of comparison. The surrounding light area is the area where liquid crystal was injected and hence the area that transmitted light. It will be appreciated that the area of liquid crystal illustrated a substantially uniform lightness to indicate that the liquid crystal was oriented in a same direction. The lightness changed uniformly as the cell is rotated relative to the polarizing plates and got to the darkest level when the bearing of plasma beam irradiation (intra-planar direction of projection of the irradiation vector) came to agree with the axis of polarization. Thus, it was confirmed that the orientation direction of the liquid crystal agrees with the intra-planar bearing of plasma bean irradiation.

The liquid crystal illustrates a substantially perpendicular homeotropic orientation on a conventional SiO oblique evaporation film. However, it was found by observing the liquid crystal cell that the liquid crystal illustrates a homogeneous orientation relative to a carbon alignment film according to the present invention. The inclination of the liquid crystal relative to the surfaces of the substrates, or the pretilt angle, is substantially equal to 0°. This is the same as that of a conventional carbon alignment film that is formed by CVD and whose surface is processed by irradiating an ion beam. A carbon film according to the present invention illustrates a directionality that is defined by the direction of plasma beam irradiation and has a property of alignment liquid crystal without processing with ions.

This property is produced by the cross-sectional structure of the alignment film formed by the FAD method as illustrated in FIG. 3A. A film having an effect of alignment liquid crystal in the direction of irradiation of carbon plasma can be formed simply by obliquely irradiating carbon plasma onto a substrate. Conventionally, a carbon film illustrating no directionality is formed and then provided with directionality by obliquely irradiating ions onto the carbon film to give an effect of alignment liquid crystal to the carbon film. However, in the present invention, a single step is required to provide a carbon film with an effect of alignment liquid crystal.

The crystal structure of a carbon film according to the present invention is not known in detail to date. Dongping Liu et al., “Influence of the incident angle of energetic carbon ions on the properties of tetrahedral amorphous carbon (ta-C) films”, Journal of Vacuum Science and Technology, 2003, A21 (5), 1665-1670 reports that a carbon film formed by oblique irradiation of carbon plasma contains amorphous carbon as principle component and has a thin graphite layer on the surface.

Now, the present invention will be described further below by way of an example.

### Example

Since a carbon film according to the present invention provides liquid crystal with a homogenous orientation, the carbon film can be applied to a liquid crystal display apparatus of in-plane switching mode for applying an electric field having a component in parallel with the surface of the substrate to control the direction of liquid crystal on the surface of the substrate.

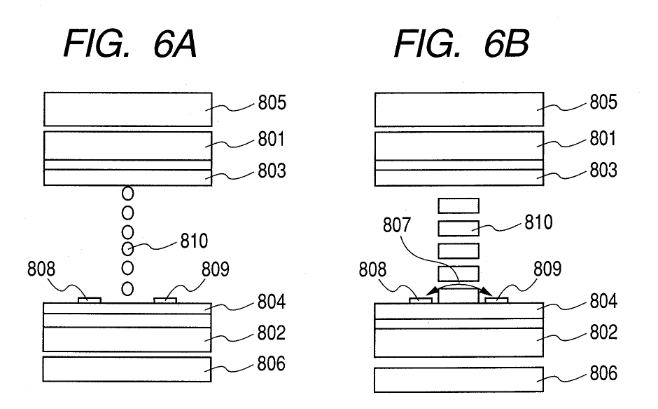

FIGS. 6A and 6B schematically illustrate a liquid crystal device of in-plane switching mode. FIG. 6A illustrates the orientation of liquid crystal molecules before application of a voltage and FIG. 6B illustrates the orientation of liquid crystal molecules during application of a voltage. A liquid crystal material illustrating positive dielectric anisotropy such as MLC-2050 described above can be used for the liquid crystal device.

Carbon films 803 and 804 that are formed by means of the above-described film forming method are arranged on the surfaces of the substrates 801 and 802 that are located vis-à-vis relative to each other. The direction of plasma irradiation is perpendicular to FIGS. 6A and 6B. Thus, the carbon films 803 and 804 give rise to a liquid crystal orientation in a direction perpendicular to the drawing. Transparent electrodes 808 and 809 are electrodes arranged vis-à-vis so as to extend in a direction perpendicular to the drawing. They are formed on the substrate 802. No electrode is formed on the substrate 801. The axis of absorption of the polarizing plate 805 is perpendicular to the drawing, whereas the axis of absorption of the polarizing plate 806 is orthogonal relative to the former axis of absorption.

The liquid crystal faces in the axial direction of the carbon films, or a direction perpendicular to the drawing, when no voltage is applied between the electrodes 808 and 809. Under this condition, light is not transmitted and the liquid crystal is in a dark state.

As an alternating voltage is applied between the electrodes 808 and 809, a transversally directed electric field is produced as indicated by arrows 807 in FIG. 6B. Then, the liquid crystal molecules 810 change the orientation according to the intensity of the electric field and its transmittance rises. FIG. 6B illustrates that, when a voltage is applied to the liquid crystal, the liquid crystal is oriented in a direction diverted from the direction perpendicular relative to the drawing. Since the liquid crystal molecules are oriented in a direction parallel to the surfaces of the substrates in the in-plane switching mode while an electric field is being applied thereto, the optical characteristics change little as a function of the viewing angle.

As provided by this example, when a carbon film obtained by the FAD method is employed as liquid crystal alignment film, the alignment effect is produced in the film forming step and a liquid crystal device that is homogeneously oriented can be obtained as a result of a liquid crystal cell forming step to a great advantage of manufacturing a liquid crystal device of in-plane switching mode.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-150304, filed Jun. 6, 2007, which is hereby incorporated by reference herein in its entirety.

1. A liquid crystal device having a pair of substrates, an alignment film formed at least on one of the pair of substrates and liquid crystal showing an orientation defined by the alignment film, wherein the alignment film is a carbon film having a cross-sectional structure inclined relative to the direction of film thickness.

2. The device according to claim 1, wherein the cross-sectional structure is a pillar structure of a substance forming the alignment film.

3. The device according to claim 1, wherein the liquid crystal is homogeneously oriented in the inclined bearing of the cross-sectional structure.

4. The device according to claim 1, wherein either of the pair of substrates is provided with a pair of electrodes and the liquid crystal is subjected to in-plane switching in the plane of substrate by applying a voltage to the electrodes.

5. A method of manufacturing a liquid crystal device including liquid crystal sandwiched between a pair of substrates, comprising a step of forming an alignment film at least on one of the pair of substrates and a step of arranging the pair of substrates opposite to each other and bonding them together with liquid crystal sandwiched between them, wherein the step of forming the alignment film is a step of forming a carbon film on either of the pair of substrates and includes steps (a) through (c) below:
(a) a step of generating a carbon plasma beam by arc discharge, using graphite as cathode;
(b) a step of curving the carbon plasma beam by means of a magnetic field; and
(c) a step of irradiating the carbon plasma beam onto the substrate from a direction inclined relative to the surface of the substrate.
